(19) United States
(12) Patent Application Publication
(10) Pub. No.: US 2006/0032660 A1
(43) Pub. Date: Feb. 16, 2006

(54) Finned jackets for LAN cables

(76) Inventors: Daniel J. Parke, Omaha, NE (US); David A. Wiebelhaus, Omaha, NE (US)

Correspondence Address: BIRCH STEWART KOLASCH & BIRCH, PO BOX 747, FALLS CHURCH, VA, 22040-0747, US

(21) Appl. No.: 11/250,543

(22) Filed: Oct. 17, 2005

Related U.S. Application Data
(63) Continuation of application No. 10/740,476, filed on Dec. 22, 2003.

(51) Int. Cl. H01B 11/02

(52) U.S. Cl. 174/113 R

(57) ABSTRACT

A cable includes a plurality of twisted wire pairs housed inside a jacket. A plurality of protrusions extend away from a circumferential surface of the jacket. The protrusion may extend radially outward from an outer circumferential surface of the jacket, or may extend radially inward from an inner circumferential surface of the jacket toward a center of the cable. The protrusions ensure that the twisted wire pairs of one cable are well-distanced from the twisted wire pairs of another cable when two cables are placed adjacent to one another and improve the dielectric properties of the jacket. The cable can be designed to meet all of telecommunication cabling industry regulations and standards, and demonstrates improved alien crosstalk and attenuation characteristics even at high data bit rates.

### BACKGROUND OF THE INVENTION

1. Field of the Invention

The present invention relates to a cable employing a plurality of twisted wire pairs. More particularly, the present invention relates to a jacket for housing the plurality of twisted wire pairs, which reduces the likelihood of transmission errors because of reduced alien crosstalk, interference from an adjacent cable, and reduced signal attenuation, and hence allows for a relatively higher bit rate transmission.

2. Description of the Related Art

Along with the greatly increased use of computers for homes and offices, there has developed a need for a cable, which may be used to connect peripheral equipment to computers and to connect plural computers and peripheral equipment into a common network. Today's computers and peripherals operate at ever increasing data transmission rates. Therefore, there is a continuing need to develop a cable, which can operate substantially error-free at higher bit rates, but also satisfy numerous elevated operational performance criteria, such as a reduction in alien crosstalk when the cable is in a high cable density application. e.g. routed alongside other cables.

FIGS. 1-3 show cables in accordance with the background art. FIG. 1 is a perspective view of an end of a cable. FIG. 2 is a cross sectional view take along the line II-II in FIG. 1. FIG. 3 is a cross sectional view, similar to FIG. 2, but showing two cables immediately adjacent to each other in a high cable density application.

FIG. 1 shows a cable M including four twisted wire pairs (a first pair A, a second pair B, a third pair C and a fourth pair D) housed inside of a common jacket J. In FIG. 1, the jacket J has been partially removed at the end of the cable M and the twisted wire pairs A, B, C and D have been separated.

FIG. 2 shows the dynamics of the four twisted wire pairs A, B, C and D inside the jacket J. The first twisted wire pair A continuously twist about each other within a space defined by the dashed line a. The second twisted wire pair B continuously twist about each other within a space defined by the dashed line b. The third twisted wire pair C continuously twist about each other within a space defined by the dashed line c. The fourth twisted wire pair D continuously twist about each other within a space defined by the dashed line d. As can be seen in FIG. 2, each wire of the twisted wire pairs A, B, C and D comes into contact with an inner circumferential wall IW of the jacket J, as the wire twists along the length of the cable M. Also, FIG. 2 illustrates a thickness t of the jacket J. A typical thickness t, which exists between the inner circumferential wall IW and an outer circumferential wall OW of the jacket J is 22 mil.

FIG. 3 illustrates a first cable M1 and a second cable M2, in accordance with the background art, placed immediately adjacent to each other. This arrangement is commonplace, especially in an office-networking environment where hundreds of cables are fed through conduits in ceilings, floors and walls into a networking closet for interconnections. As can be seen in FIG. 3, each wire of the twisted wire pairs A, B, C and D in the first cable M1 will, at times, be spaced from the wires of the twisted wire pairs A, B, C and D in the second cable M2 by a distance 2 t, or twice the thickness t of the jacket J.

The cables of the background art suffers drawbacks. Namely, the background art's cable exhibits unacceptable levels of Alien Near End Crosstalk (ANEXT) and Alien Far End Crosstalk (AFEXT), especially at higher data transmission rates. To measure the ANEXT and AFEXT of the pairs in a cable, an industry standard testing technique, making use of a vector network analyzer (VNA), is employed.

Briefly, an output of the VNA is connected to pair A of the second cable M2 while an input of the VNA is connected to pair A of the first cable M1. The VNA output sweeps over a band of frequencies, e.g. from 0.500 MHz to 1000 MHz, and the ratio of the signal strength detected on pair A of the first cable M1 over the signal strength applied to the pair A in the second cable M2 is read and recorded. This is the ANEXT or AFEXT contributed to the pair A in the first cable M1 from the pair A in the second cable M2. Contributions to the pair A in first cable M1 from the other pairs B, C and D in the second cable M2 are acquired in the same manner.

The contributions from the pairs A, B, C and D in second cable M2 to the pair A in the first cable M1 are summed and considered to be the ANEXT and AFEXT performance for the pair A in cable M1. The above procedure is repeated for the second, third and fourth twisted wire pairs B, C and D of the first cable M1 to obtain the ANEXT and AFEXT for the second, third and fourth pairs B, C and D. The difference between alien near end crosstalk (ANEXT) and alien far end crosstalk (AFEXT) is that for ANEXT, the signal output for the tested pair is read from the same end, e.g. the near end, of the cable that the input sweeping test signals are applied. For AFEXT, the signal output for the tested pair is read from the opposite end, e.g. the far end, of the cable relative to the end into which the input sweeping test signals are applied.

The ANEXT and AFEXT performance is unacceptable in the cables according to the background art because when the first cable M1 and the second cable M2 are placed immediately adjacent to each other, the spacing 2 t allows for cross capacitance/cross inductance between the wires in the first cable M1 and the wires in the second cable M2. This cross capacitance and cross inductance results in particularly high levels of cross talk, particularly as the data bit rates of transmission increase.

### SUMMARY OF THE INVENTION

One possible solution to this drawback would be to improve, i.e. lower, the dielectric constant of the jacket material. Improving the dielectric material of the jacket would reduce cross capacitance and cross inductance between the wires of the first cable M1 and the wires of the second cable M2. However, typical listing and code requirements set minimum smoke and/or flame retardant standards for the cable. In order to surpass these minimum standards, the materials typically used to form the jacket are PVC compounds. Such compounds have inferior dielectric properties.

Another possible solution would be to add a shielding layer inside the jacket, surrounding the twisted wire pairs therein. This solution greatly reduces the crosstalk between cables. However, adding a shielding layer to a cable complicates the manufacturing process, changes the telecommunication network to incorporate grounding and requiring different interconnection components, and greatly increases the cost of the cable and the network.

Another possible solution would be to increase the thickness of the jacket. It is understood that increasing the distance between two wires carrying signals will reduce the cross capacitance/cross inductance, and hence lower the crosstalk therebetween. However, this solution also suffers drawbacks. Increasing the thickness of the jacket increases the costs of the cable, the weight of the cable, and the rigidity of the cable. It also increases signal attenuation, reducing signal strength, associated with having more material with a higher dielectric constant and dissipation factor surrounding the plurality of twisted pairs. The added weight and rigidity make installations more troublesome. Moreover, the presence of added jacket material could cause the cable to fail smoke and/or flame tests, as more material is present to smoke and or burn.

A solution, in accordance with the present invention, addresses one or more of the drawbacks associated with the background art, while avoiding the additional drawbacks mentioned above.

It is an object of the present invention to provide a cable with a jacket configuration, which improves the alien crosstalk and attenuation performance of the cable, as compared to existing cables.

It is an object of the present invention to provide a cable with an improved attenuation and crosstalk performance, which meets or surpasses the minimum standards to qualify as a telecommunications cable, such as UL Subject 444, and EIA/TIA 568.

These and other objects are accomplished by a cable including a plurality of conductors housed inside a jacket. A plurality of protrusions extends away from a circumferential surface of the jacket. The protrusion may extend outwardly from an outer circumferential surface of the jacket, or may extend inward from an inner circumferential surface of the jacket. The protrusions ensure that the twisted wire pairs of one cable are well distanced from the twisted wire pairs of another cable when two cables are placed adjacent to one another. The cable can be designed to meet the requirements of telecommunications cabling standards including UL Subject 444, and EIA/TIA 568 standards and demonstrates reduced attenuation and crosstalk characteristics even at high data bit rates.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a perspective view of an end of a cable having a jacket removed to show four twisted wire pairs, in accordance with the background art;

FIG. 2 is a cross sectional view taken along line 11-11 in FIG. 1, in accordance with the background art;

FIG. 3 is a cross sectional view similar to FIG. 2, but showing two cables immediately adjacent to each other in a high cable density application, in accordance with the background art;

FIG. 4 is a cross sectional view of a cable having triangular-shaped outwardly extending protrusions on an outer circumferential wall of the cable's jacket;

FIG. 5 is a cross sectional view of four adjacent cables, constructed in accordance with FIG. 4;

FIG. 6 is a cross sectional view of a cable having rectangular-shaped outwardly extending protrusions on an outer circumferential wall of the cable's jacket;

FIG. 7 is a cross sectional view of four adjacent cables, constructed in accordance with FIG. 6;

FIG. 8 is a cross sectional view of a cable having triangular-shaped inwardly extending protrusions on an inner circumferential wall of the cable's jacket, in accordance with the present invention;

FIG. 9 is a cross sectional view of four adjacent cables, constructed in accordance with FIG. 8;

FIG. 10 is a cross sectional view of a cable having rectangular-shaped inwardly extending protrusions on an inner circumferential wall of the cable's jacket, in accordance with the present invention; and

FIG. 11 is a cross sectional view of four adjacent cables, constructed in accordance with FIG. 10.

### DETAILED DESCRIPTION OF A PREFERRED EMBODIMENT

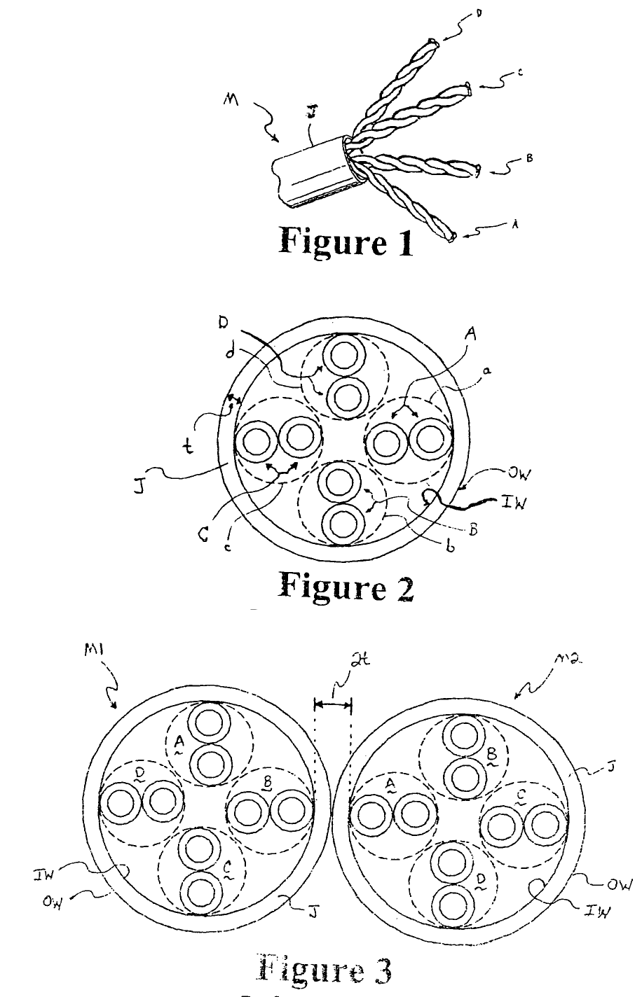

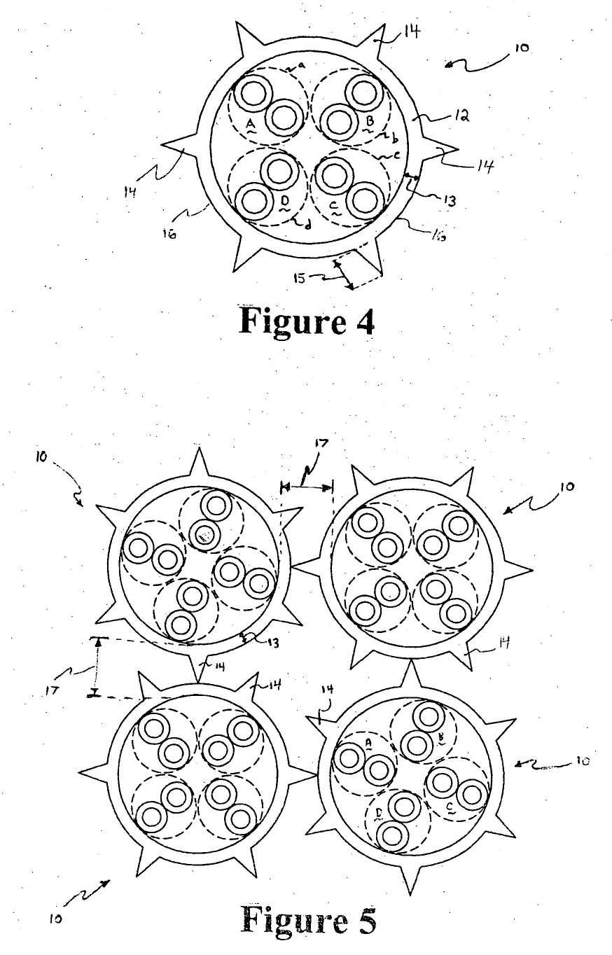

FIG. 4 is a cross sectional view of a cable 10, in accordance with a first embodiment of the present invention. The cable 10 includes the first, second, third and fourth twisted wire pairs A, B, C and D, which are the same or similar to the twisted wire pairs illustrated in FIGS. 1-3.

The cable 10 includes a jacket 12. The jacket 12 may be formed of a smoke or fire retardant material, such as a PVC compound. A thickness 13 of the jacket 12 is preferably about 20 mils.

A plurality of protrusions 14 is formed on an outer circumferential wall 16 of the jacket 12. The protrusions 14 have a triangular shape and a thickness 15, which is preferably about 30 mils. The protrusions 14 extend radially outward, away from a center of the cable 10. The protrusions 14 may be integrally formed with the jacket 12 during an initial extrusion process to form the jacket 12.

Although FIG. 4 illustrates six protrusions 14 integrally formed with the jacket 12, it should be noted that more or less protrusions 14 may be included. For example, a cable 10 with ten or more protrusions 14, such as twelve, eighteen or nineteen protrusions 14 would equally serve the advantages of the present invention. Moreover, other known materials, besides PVC compounds, can be employed in the construction of the jacket 12. Also, the dimensions of the jacket's thickness 13 and each protrusion's thickness 15 are given by way of example only. Other values may be chosen for the jacket's thickness 13 and the protrusion's thickness 15, and are considered to be within the purview of the present invention.

FIG. 5 is a cross sectional view illustrating four cables 10 placed immediately adjacent to each other. Such a configuration would occur when four cables 10 are ran through a common conduit on the way to or from a network connection closet in an office environment. As can be seen in FIG. 5, the protrusions 14 of the cables 10 engage the outer circumferential walls 16 of the other cables 10. The engagement ensures a minimum spacing 17 between the twisted wire pairs A, B, C and D within one of the cables 10 and the twisted wire pairs A, B, C and D in another of the cables 10. The spacing 17 is ensured to be greater than the thickness 15 of the protrusion 14 plus twice the thickness 13 of the jacket 12.

By the present invention, the alien crosstalk performance of the cable 10 is greatly improved without the expense of providing a dedicated shielding layer. Further, the crosstalk performance is improved without having to resort to more expensive materials to form the jacket, which might have a lower dielectric value at the expense of poorer performance in a smoke or flame test. Furthermore, the spacing between the cables is increased without increasing an overall thickness of the jacket, thereby keeping the weight, rigidity and material volume of the jacket to a minimum. By the present invention, the attenuation performance of the cable 10 is greatly improved along with alien crosstalk since air with a lower dielectric constant and dissipation factor substance is incorporated into the jacket continuum. Having air next to the twisted pair has the greatest impact in improving attenuation.

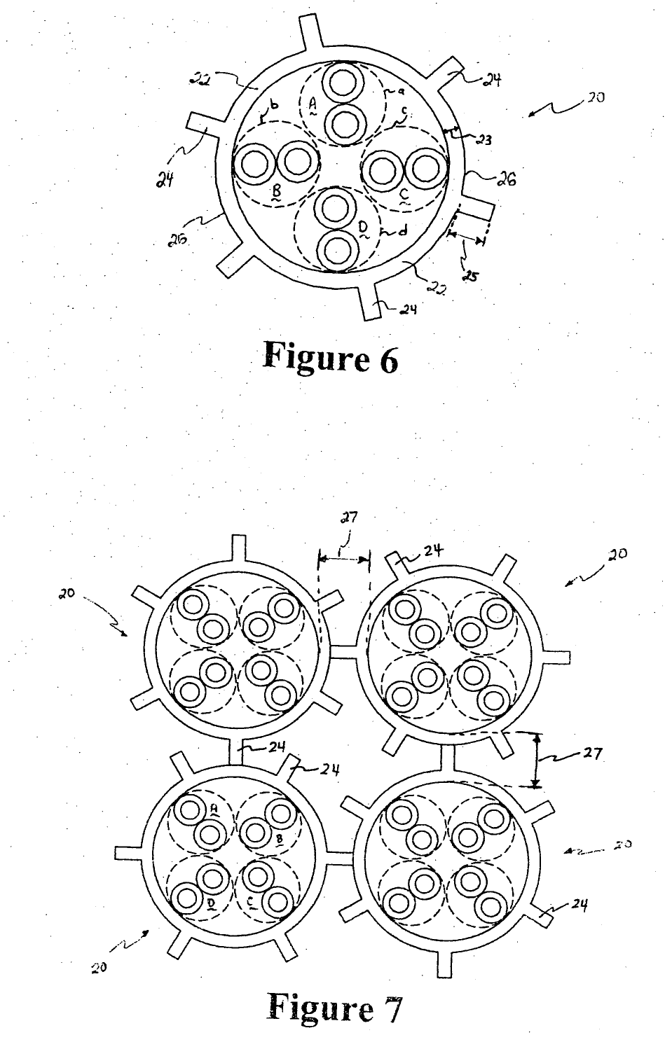

FIG. 6 is a cross sectional view of a cable 20, in accordance with a second embodiment of the present invention. The cable 20 includes the first, second, third and fourth twisted wire pairs A, B, C and D, which are the same or similar to the twisted wire pairs illustrated in FIGS. 1-3.

The cable 20 includes a jacket 22. The jacket 22 may be formed of a smoke or fire retardant material, such as a PVC compound. A thickness 23 of the jacket 22 is preferably about 20 mils.

A plurality of protrusions 24 is formed on an outer circumferential wall 26 of the jacket 22. The protrusions 24 have a rectangular shape and a thickness 25, which is preferably about 30 mils. The protrusions 24 extend radially outward, away from a center of the cable 20. The protrusions 24 may be integrally formed with the jacket 22 during an initial extrusion process to form the jacket 22.

Although FIG. 6 illustrates six protrusions 24 integrally formed with the jacket 22, it should be noted that more or less protrusions 24 may be included. For example, a cable 20 with ten or more protrusions 24, such as twelve, eighteen or nineteen protrusions 24 would equally serve the advantages of the present invention. Moreover, other known materials, besides PVC compounds, can be employed in the construction of the jacket 22. Also, the dimensions of the jacket's thickness 23 and each protrusion's thickness 25 are given by way of example only. Other values may be chosen for the jacket's thickness 23 and the protrusion's thickness 25, and are considered to be within the purview of the present invention.

FIG. 7 is a cross sectional view illustrating four cables 20 placed immediately adjacent to each other. Such a configuration would occur when four cables 20 are ran through a common conduit on the way to or from a network connection closet in an office environment. As can be seen in FIG. 7, the protrusions 24 of the cables 20 engage the outer circumferential walls 26 of the other cables 20. The engagement ensures a minimum spacing 27 between the twisted wire pairs A, B, C and D within one of the cables 20 and the twisted wire pairs A, B, C and D in another of the cables 20. The spacing 27 is ensured to be greater than the thickness 25 of the protrusion 24 plus twice the thickness 23 of the jacket 22.

By the present invention, the crosstalk performance of the cable 20 is greatly improved without the expense of providing a dedicated shielding layer. Further, the crosstalk performance is improved without having to resort to more expensive materials to form the jacket, which might have a lower dielectric value at the expense of poorer performance in a smoke or flame test. Further, signal attenuation is reduced associated with the inclusion of air with a lower dielectric value into the jacket continuum. Furthermore, the spacing between the cables is increased without increasing an overall thickness of the jacket, thereby keeping the weight, rigidity and material volume of the jacket to a minimum.

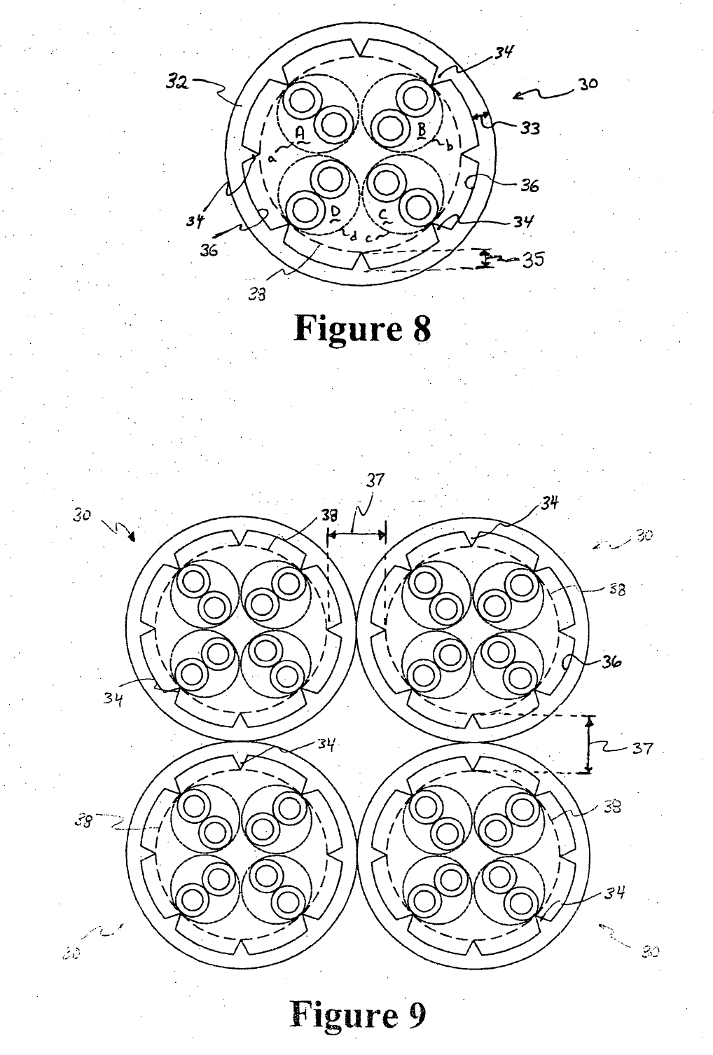

FIG. 8 is a cross sectional view of a cable 30, in accordance with a third embodiment of the present invention. The cable 30 includes the first, second, third and fourth twisted wire pairs A, B, C and D, which are the same or similar to the twisted wire pairs illustrated in FIGS. 1-3.

The cable 30 includes a jacket 32. The jacket 32 may be formed of a smoke or fire retardant material, such as a PVC compound. A thickness 33 of the jacket 32 is preferably about 20 mils.

A plurality of protrusions 34 is formed on an inner circumferential wall 36 of the jacket 32. The protrusions 34 have a triangular shape and a thickness 35, which is preferably about 20 mils. The protrusions 34 extend radially inward, toward a center of the cable 30. The protrusions 34 may be integrally formed with the jacket 32 during an initial extrusion process to form the jacket 32.

Although FIG. 8 illustrates eight protrusions 34 integrally formed with the jacket 32, it should be noted that more or less protrusions 34 may be included. For example, a cable 30 with ten or more protrusions 34, such as twelve, eighteen or nineteen protrusions 34 would equally serve the advantages of the present invention. Moreover, other known materials, besides PVC compounds, can be employed in the construction of the jacket 32. Also, the dimensions of the jacket's thickness 33 and each protrusion's thickness 35 are given by way of example only. Other values may be chosen for the jacket's thickness 33 and the protrusion's thickness 35, and are considered to be within the purview of the present invention.

FIG. 9 is a cross sectional view illustrating four cables 30 placed immediately adjacent to each other. Such a configuration would occur when four cables 30 are ran through a common conduit on the way to or from a network connection closet in an office environment. As can be seen in FIG. 9, the protrusions 34 of the cables 30 engage the twisted wire pairs A, B, C and D inside the cable 30 and create an effective inner diameter 38 within the inner circumferential wall 36 of the jacket 32. The twisted wire pairs A, B, C and D are no longer pressed against the inner circumferential wall 36. Rather, the twisted wire pairs A, B, C and D are engaged and held a distance away from the inner circumferential wall 36 equal to the thickness 35 of the protrusions 34.

The engagement ensures a minimum spacing 37 between the twisted wire pairs A, B, C and D within one of the cables 30 and the twisted wire pairs A, B, C and D in another of the cables 30. The spacing 37 is ensured to be greater than twice the thickness 35 of the protrusions 34 plus twice the thickness 33 of the jacket 32.

By the present invention, the crosstalk performance of the cable 30 is greatly improved without the expense of providing a dedicated shielding layer. Further, the crosstalk performance is improved without having to resort to more expensive materials to form the jacket, which might have a lower dielectric value at the expense of poorer performance in a smoke or flame test. Further, signal attenuation is reduced associated with the inclusion of air with a lower dielectric value into the jacket continuum. Furthermore, the spacing between the cables is increased without increasing an overall thickness of the jacket, thereby keeping the weight, rigidity and material volume of the jacket to a minimum.

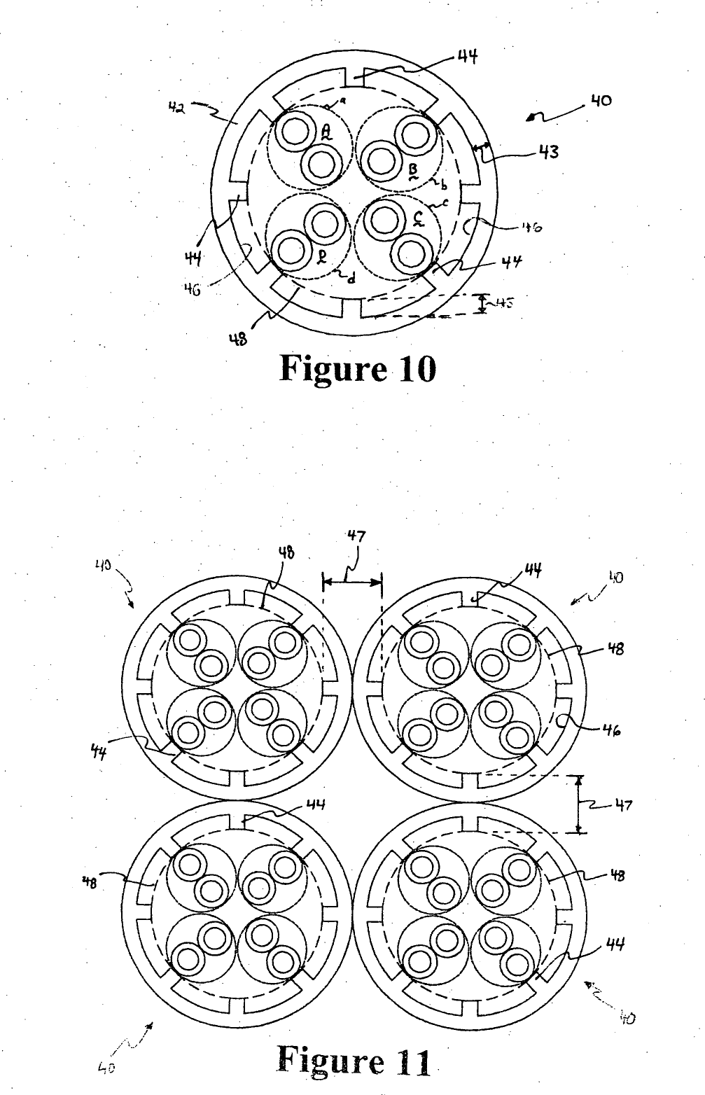

FIG. 10 is a cross sectional view of a cable 40, in accordance with a fourth embodiment of the present invention. The cable 40 includes the first, second, third and fourth twisted wire pairs A, B, C and D, which are the same or similar to the twisted wire pairs illustrated in FIGS. 1-3.

The cable 40 includes a Jacket 42. The jacket 42 may be formed of a smoke or fire retardant material, such as a PVC compound. A thickness 43 of the jacket 42 is preferably about 20 mils.

A plurality of protrusions 44 is formed on an inner circumferential wall 46 of the jacket 42. The protrusions 44 have a rectangular shape and a thickness 45, which is preferably about 20 mils. The protrusions 44 extend radially inward, toward a center of the cable 40. The protrusions 44 may be integrally formed with the jacket 42 during an initial extrusion process to form the jacket 42.

Although FIG. 10 illustrates eight protrusions 44 integrally formed with the jacket 42, it should be noted that more or less protrusions 44 may be included. For example, a cable 40 with ten or more protrusions 44, such as twelve, eighteen or nineteen protrusions 44 would equally serve the advantages of the present invention. Moreover, other known materials, besides PVC compounds, can be employed in the construction of the jacket 42. Also, the dimensions of the jacket's thickness 43 and each protrusion's thickness 45 are given by way of example only. Other values may be chosen for the jacket's thickness 43 and the protrusion's thickness 45, and are considered to be within the purview of the present invention.

FIG. 11 is a cross sectional view illustrating four cables 40 placed immediately adjacent to each other. Such a configuration would occur when four cables 40 are ran through a common conduit on the way to or from a network connection closet in an office environment. As can be seen in FIG. 11, the protrusions 44 of the cables 40 engage the twisted wire pairs A, B, C and D inside the cable 40 and create an effective inner diameter 48 within the inner circumferential wall 46 of the jacket 42. The twisted wire pairs A, B, C and D are no longer pressed against the inner circumferential wall 46. Rather, the twisted wire pairs A, B, C and D are engaged and held a distance away from the inner circumferential wall 46 equal to the thickness 45 of the protrusions 44.

The engagement ensures a minimum spacing 47 between the twisted wire pairs A, B, C and D within one of the cables 40 and the twisted wire pairs A, B, C and D in another of the cables 40. The spacing 47 is ensured to be greater than twice the thickness 45 of the protrusions 44 plus twice the thickness 43 of the jacket 42.

By the present invention, the crosstalk performance of the cable 40 is greatly improved without the expense of providing a dedicated shielding layer. Further, the crosstalk performance is improved without having to resort to more expensive materials to form the jacket, which might have a higher dielectric value at the expense of poorer performance in a smoke or flame test. Furthermore, the spacing between the cables is increased without increasing an overall thickness of the jacket, thereby keeping the weight, rigidity and material volume of the jacket to a minimum 37.

The various embodiments of the above-described cable can be formed by extruding the dielectric material, forming the jacket and protrusions, onto the twisted wire pairs. More specifically, first, second, third and fourth twisted wire pairs are twisted about each other to form a core strand. The core strand is stored on a first spool.

Later, the core strand is deployed from the first spool into an extrusion machine. The core strand passes though an opening in the machine, around which the dielectric material is extruded. In conventional operations, the extruded jacket has an overall circular cross sectional shape. However, in the present invention, the conventional extrusion plate, causing the circular cross sectional shape, is replaced by an extrusion plate causing the complex cross sectional shape, with protrusions. After the extrusion process, the cable is passed through a liquid cooling bath, through a drying process, a printing process (to print cable indicia on the outer walls of the jacket), and onto a second or take-up spool.

As disclosed above, a cable constructed in accordance with the present invention shows a high level of immunity to alien NEXT and FEXT, which translates into a cabling media capable of faster data transmission rates and a reduced likelihood of data transmission errors.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A cable comprising:
a first twisted wire pair including first and second conductors, each separately surrounded by an insulation, wherein the first conductor and the second conductor are continuously twisted about each other along a length of the cable;
a second twisted wire pair including third and fourth conductors, each separately surrounded by an insulation, wherein the third conductor and the fourth conductor are continuously twisted about each other along the length of the cable;
a jacket surrounding the first and second twisted wire pairs; and
a plurality of protrusions extending away from an inner circumferential surface of said jacket generally toward a center of said cable by at least about 20 mils, wherein ends of said plurality of protrusions abut said first and second twisted wire pairs to hold said first and second twisted wire pairs away from said inner circumferential surface of said jacket.

2. The cable of claim 1, wherein said inner circumferential surface is a curved surface approximately following a fixed radius about said center of said jacket.

3-7. (canceled)

8. The cable of claim 1, wherein each protrusion of said plurality of protrusions is integrally formed with said jacket.

9. (canceled)

10. The cable of claim 1, wherein said jacket has an outer circumferential surface with a generally circular cross sectional shape, and wherein said plurality of protrusions extend radially inward from said inner circumferential surface, said inner circumferential surface also having a generally circular cross sectional shape.

11. The cable of claim 1, wherein each protrusion of said plurality of protrusions has a generally triangular cross sectional shape.

12. The cable of claim 1, wherein each protrusion of said plurality of protrusions has a generally rectangular cross sectional shape.

13. The cable of claim 1, wherein said plurality of protrusions includes at least six protrusions.

14. (canceled)

15. The cable of claim 1, wherein a radial thickness of said jacket is approximately 20 mil.

16. The cable of claim 1, wherein an overall diameter of said cable is approximately 0.3 inches.

17. The cable of claim 1, wherein said jacket and said plurality of protrusions are formed of a dielectric material.

18. The cable according to claim 1, further comprising:
a third twisted wire pair including fifth and sixth conductors, each separately surrounded by an insulation, wherein the fifth conductor and the sixth conductor are continuously twisted about each other along the length of the cable; and
a fourth twisted wire pair including seventh and eighth conductors, each separately surrounded by an insulation, wherein the seventh conductor and the eighth conductor are continuously twisted about each other along the length of the cable, wherein said jacket also surrounds said third and fourth twisted wire pairs, and wherein ends of said plurality of protrusions abut said third and fourth twisted wire pairs to hold said first, second, third and fourth twisted wire pairs away from said inner circumferential surface of said jacket.

19. (canceled)

20. The cable of claim 1, wherein said cable meets the specifications of UL Subject ELA/TIA 568.

21-38. (canceled)

39. A cable comprising:
a first twisted wire pair including first and second conductors, each separately surrounded by an insulation, wherein the first conductor and the second conductor are continuously twisted about each other along a length of the cable;
a second twisted wire pair including third and fourth conductors, each separately surrounded by an insulation, wherein the third conductor and the fourth conductor are continuously twisted about each other along the length of the cable;
a jacket surrounding the first and second twisted wire pairs, wherein said jacket has an outer circumferential wall with a generally circular cross sectional shape, and an inner circumferential wall, also having a generally circular cross sectional shape; and
a plurality of protrusions extending away from said inner circumferential wall of said jacket generally toward a center of said cable, wherein surfaces of said inner circumferential wall between adjacent projections are arc-shaped following said generally circular cross sectional shape of said inner circumferential wall, and wherein ends of said plurality of protrusions abut said first and second twisted wire pairs to hold said first and second twisted wire pairs away from said inner circumferential wall of said jacket.

40. The cable of claim 39, wherein a radial thickness of said jacket measured between said outer circumferential wall and said inner circumferential wall is approximately 20 mil.

41. The cable of claim 39, wherein each protrusion of said plurality of protrusions has a generally triangular cross sectional shape.

42. The cable of claim 39, wherein each protrusion of said plurality of protrusions has a generally rectangular cross sectional shape.

43. The cable of claim 39, wherein said plurality of protrusions includes at least six protrusions.

44. The cable of claim 39, wherein an overall diameter of said cable is approximately 0.3 inches.

45. The cable of claim 39, wherein said jacket and said plurality of protrusions are formed of a dielectric material.

46. The cable of claim 39, wherein said cable meets the specifications of UL Subject EIA/TIA 568.

47. A cable comprising:
a plurality of conductors;
a cable jacket formed of a dielectric material and formed to surround said plurality of conductors, wherein said cable jacket has an outer circumferential wall with a generally circular cross sectional shape, and an inner circumferential wall, also having a generally circular cross sectional shape; and
a plurality of protrusions formed of a dielectric material extending away from said inner circumferential wall of said cable jacket generally toward a center of said cable, wherein said plurality of protrusions cause an air gap between said plurality of conductors and said inner circumferential wall of said jacket.

48. The cable of claim 47, wherein said plurality of protrusions extend away from said inner circumferential wall of said cable jacket generally toward said center of said cable by at least about 20 mils.

49. The cable of claim 48, wherein a radial thickness of said jacket measured between said outer circumferential wall and said inner circumferential wall is approximately 20 mil.

50. A cable comprising:
a first twisted wire pair including first and second conductors, each separately surrounded by an insulation, wherein the first conductor and the second conductor are continuously twisted about each other along a length of the cable;
a second twisted wire pair including third and fourth conductors, each separately surrounded by an insulation, wherein the third conductor and the fourth conductor are continuously twisted about each other along the length of the cable;
a jacket surrounding the first and second twisted wire pairs; and
a plurality of protrusions extending away from a circumferential surface of said jacket, wherein said circumferential surface is an outer circumferential surface of said jacket, and said plurality of protrusions extend generally away from a center of said cable.

51. The cable of claim 50, wherein each protrusion of said plurality of protrusions has a generally triangular cross sectional shape.

52. The cable of claim 50, wherein each protrusion of said plurality of protrusions has a generally rectangular cross sectional shape.

53. The cable of claim 50, wherein said jacket is extruded onto said first and second twisted wire pairs.

54. The cable of claim 50, wherein each protrusion of said plurality of protrusions is integrally formed with said jacket, and wherein said jacket and said plurality of protrusions are formed of a dielectric material.

55. The cable of claim 50, wherein said plurality of protrusions includes at least six protrusions.

56. The cable of claim 50, wherein a radial thickness of said jacket is approximately 20 mil, and a radial thickness of each of said plurality of protrusions is approximately 30 mil.

57. The cable of claim 50, wherein the cable meets the specifications of UL Subject EIA/TIA 568.

58. A cable comprising:
a plurality of conductors;
a cable jacket formed of a dielectric material and formed to surround said plurality of conductors; and
a plurality of protrusions extending away from an outer circumferential surface of said cable jacket.

59. The cable of claim 58, wherein said plurality of protrusions extend generally away from a center of said cable.

60. The cable of claim 59, wherein each protrusion of said plurality of protrusions has a generally triangular or rectangular cross sectional shape.

61. The cable of claim 58, wherein each protrusion of said plurality of protrusions is integrally formed with said cable jacket.
